(19) United States
(12) Patent Application Publication
(10) Pub. No.: US 2023/0406679 A1
(43) Pub. Date: Dec. 21, 2023

(54) Vehicle Air Lift System

(71) Applicant: Christopher Hobbs, Calgary (CA)

(72) Inventor: Christopher Hobbs, Calgary (CA)

(21) Appl. No.: 17/841,554

(22) Filed: Jun. 15, 2022

(51) Int. Cl. B66F 3/35

(52) U.S. Cl. CPC B66F 3/35; B66F 2700/12

(57) ABSTRACT

A system and method for lifting a vehicle using compressed air is disclosed herein. The system includes a set of inflatable devices movable into an inflated position to lift the vehicle; and an air-line assembly connectable to a compressed air supply and to the set of the inflatable devices to move the set of inflatable devices into the inflated position. The system may lift the vehicle completely off of the ground in less than 30 seconds. As such, tire rotations, seasonal tire swaps, etc. are made easy and time effective.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of vehicle jacks of existing art and more specifically relates to a pneumatic vehicle jack system.

### RELATED ART

There are various reasons in which it is necessary to lift a vehicle off of the ground. For example, when changing a tire, changing engine oil, inspecting brakes, etc. Most typically, to lift a vehicle off the ground, a car jack is used. A car jack is a mechanical lifting device operated by placing the car jack underneath the vehicle, positioning it underneath jacking points of the vehicle and then manually operating the car jack, either via pumping or winding (depending on type of car jack used), to lift the vehicle.

However, there are many disadvantages to these mechanical car jacks. One such disadvantage is that the accurate positioning of the car jack and the subsequent manually pumping or winding of the car jack is a time consuming and a laborious task. This is particularly true for tire shops and mechanic shops consistently having to lift different vehicles. As such, a suitable solution is desired.

### SUMMARY OF THE INVENTION

In view of the foregoing disadvantages inherent in the known vehicle jack art, the present disclosure provides a novel vehicle air lift system. The general purpose of the present disclosure, which will be described subsequently in greater detail, is to provide a system that allows for the lifting of a load, particularly a vehicle, using compressed air.

A system for lifting a vehicle using compressed air is disclosed herein. The system includes a set of inflatable devices configured for movement between an inflated position and a deflated position and an air-line assembly. The set of inflatable devices each include a base, a main body, an inflation control unit and a support plate. The base may include a substantially planar body. The main body may be attached to the base and may be defined by at least two airbags stacked vertically and sharing a common interior. Further, the support plate may be attached atop the main body.

The inflation control unit may be attached to the base and in communication with the common interior. The inflation control unit may include an inlet. The air-line assembly may include a conduit system and a main control valve. The main control valve may be configured for connection with a compressed air supply to intake compressed air into the air-line assembly and the conduit system may be configured to supply the compressed air to the inlet of each of the set of inflatable devices, thereby moving the set of inflatable devices into the inflated position and lifting the vehicle.

According to another embodiment, a method of lifting a vehicle using compressed air is also disclosed herein. The method includes providing the system as above; positioning each of the set of inflatable devices underneath the vehicle such that the support plate of each of the set of inflatable devices abuts an underside of the vehicle; connecting the air-line assembly to the inflation control unit on each of the set of inflatable devices; connecting the main control valve with the compressed air supply; and manipulating the main control valve to enable conveyance of the compressed air through the air-line assembly and into the inlet of each of the set of inflatable devices, thereby filling the common interior of each of the set of inflatable devices with compressed air, moving the set of inflatable devices into the inflated position, and lifting the vehicle.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a vehicle air lift system, constructed and operative according to the teachings of the present disclosure.

FIG. 1 is a front perspective view of a system being used to lift a vehicle using compressed air, according to an embodiment of the disclosure.

FIG. 2 is a side perspective view of the system of FIG. 1, according to an embodiment of the present disclosure.

FIG. 3 is a close-up view of the system of FIG. 1 and illustrating an inflatable device according to an embodiment of the present disclosure.

FIG. 4 is a rear perspective view of the inflatable device, according to an embodiment of the present disclosure.

FIG. 5 is a partial cross-section view of the inflatable device in a deflated position, according to an embodiment of the present disclosure.

FIG. 6 is a partial cross-section view of the inflatable device in an inflated position, according to an embodiment of the present disclosure.

FIG. 7 is a top view of a set of inflatable devices joined together via a set of telescopic members, according to an embodiment of the present disclosure.

FIG. 8 is a pictorial diagram of the system including an air-line assembly and a set of inflatable devices, according to an embodiment of the present disclosure.

FIG. 9 is a pictorial diagram of the system including the air-line assembly and the set of inflatable devices, according to another embodiment of the present disclosure.

FIG. 10 is a pictorial diagram of the system including the air-line assembly and the set of inflatable devices, according to another embodiment of the present disclosure.

FIG. 11 is a pictorial diagram of the system being stored in a bed of a truck, according to another embodiment of the present disclosure.

FIG. 12 is a pictorial diagram of a plurality of systems, according to another embodiment of the present disclosure.

FIG. 13 is a flow diagram illustrating a method of lifting a vehicle using compressed air, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a vehicle jack and more particularly to a vehicle air lift system. Generally, the vehicle air lift system may include a set of four triple air bladder jacks connected together via air-lines that work in unity to lift a vehicle completely off of the ground in less than 30 seconds. As such, tire changes or rotations in particular are made easy and time effective.

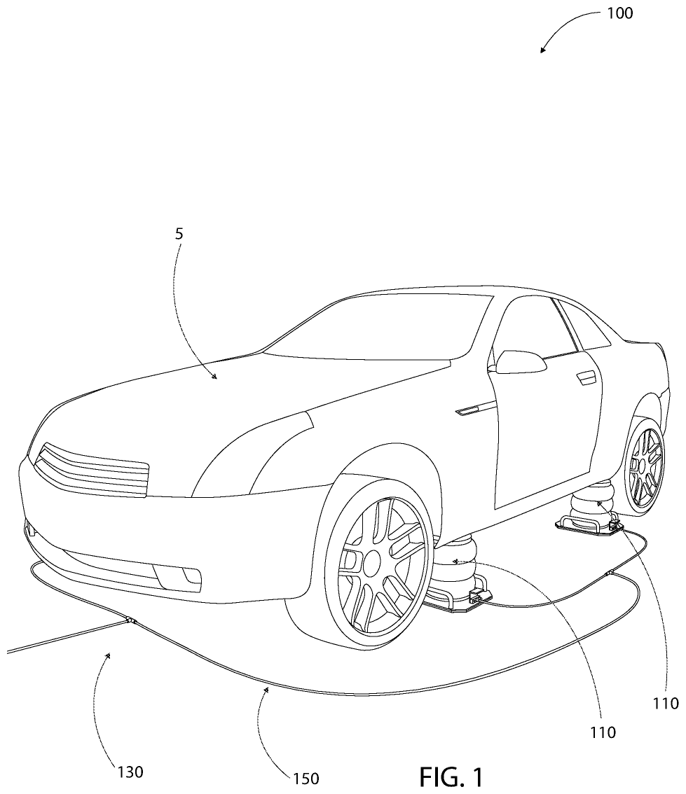

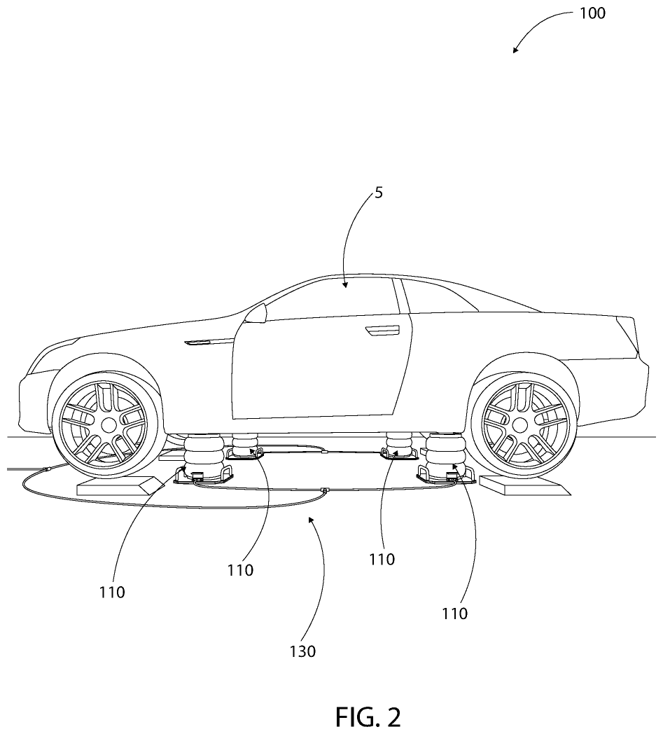

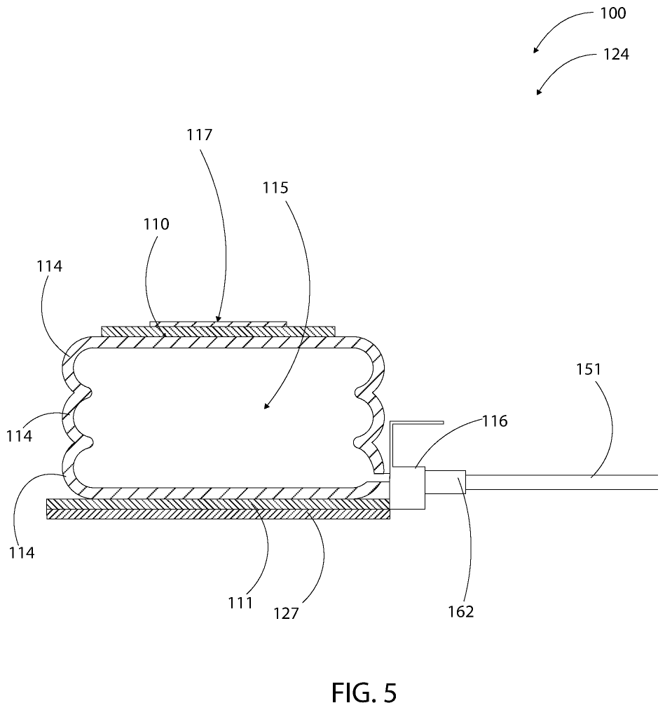

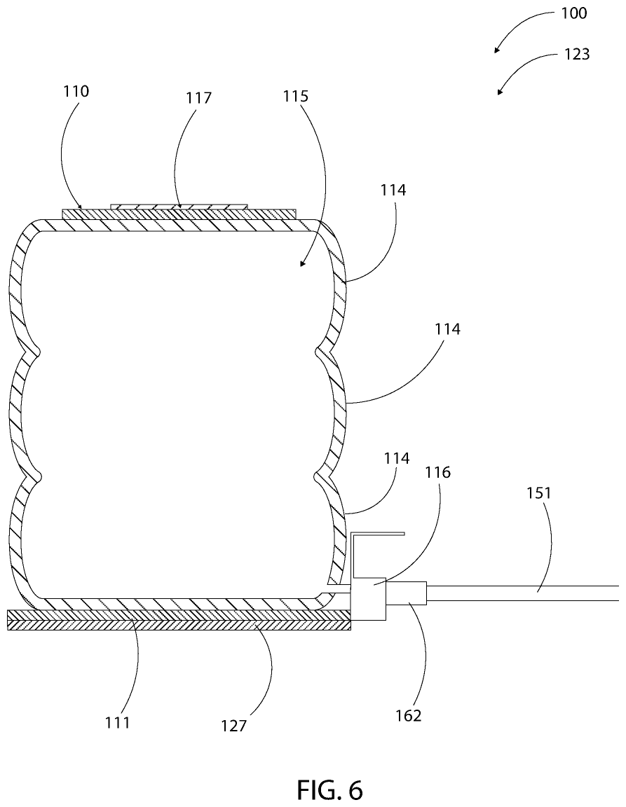

Referring now more specifically to the drawings by numerals of reference, there is shown in FIGS. 1-12, various views of a system 100 for lifting a vehicle using compressed air. As shown, the system 100 may include a set of inflatable devices 110 and an air-line assembly 130. The set of inflatable devices 110 may be configured for movement between an inflated position 123 and a deflated position 124. As demonstrated in these figures and particularly in FIGS. 5-6, in the inflated position 123 (FIG. 6), the set of inflatable devices 110 may include a greater height than in the deflated position 124 (FIG. 5). As such, in the inflated position 123, the set of inflatable devices 110 may lift the vehicle 5 (FIGS. 1-2). Thereby, the set of inflatable devices 110 each act as a car jack.

Preferably, the set of inflatable devices 110 may include four inflatable devices 110. As such, as shown in FIGS. 1-2, two of the four inflatable devices 110 may be placed toward a rear of the vehicle 5 and the other two of the four inflatable devices 110 may be placed toward a front of the vehicle 5. Further, in some embodiments, as demonstrated in FIG. 1, the system 100 may include one or more height increasing lifts 128. The height increasing lift(s) 128 may enable a lowered vehicle to drive thereonto and create enough clearance to place each of the set of inflatable devices 110 under jacking points of the vehicle 5.

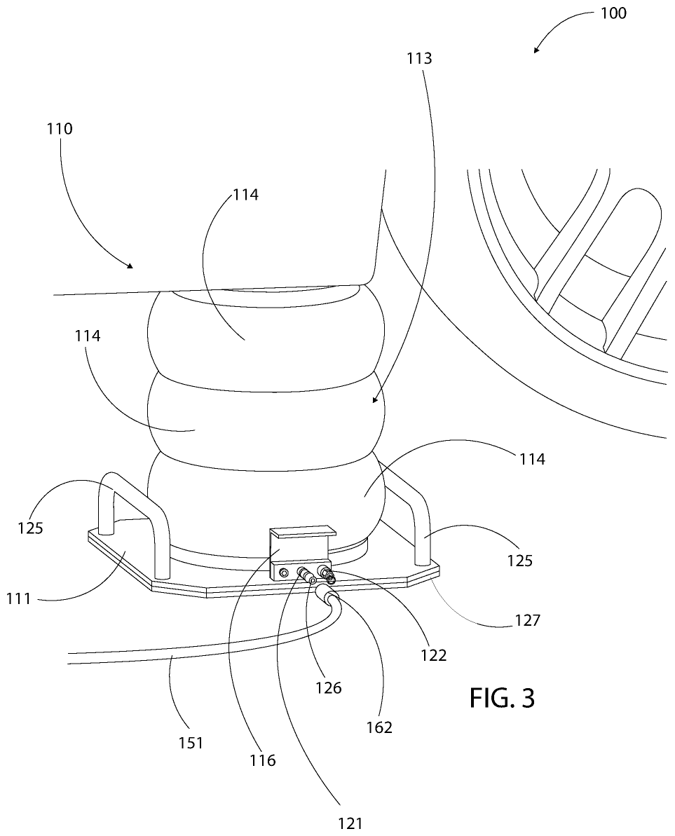

As shown in FIGS. 3-6, each of the set of inflatable devices 110 may include a base 111, a main body 113, an inflation control unit 116 and a support plate 117. In some embodiments, each of the set of inflatable devices 110 may include a width of between 12-13 inches as measured from one side of the base 111 to an opposite side of the base 111; and a height of between 5-6 inches as measured from a bottom of the base 111 to a top of the support plate 117 when in the deflated position 124. It should however be appreciated that these measurements are given as examples and are not meant to limit the inflatable devices 110 to any particular size.

The base 111 may be made of a heavy duty material, such as a steel material, and may include a substantially planar body 112. Further, as shown in FIG. 3 particularly, the base 111 may include a pair of handles 125 attached either side thereof, enabling a user to easily transport each inflatable device 110. Further, in some embodiments, each of the set of inflatable devices 110 may further include a non-slip pad 127. The non-slip pad 127 may include (but is not limited to) a thickness of ¼ inches and may be made from a rubber material (but again is not limited to this material). As shown in FIGS. 1-6, the non-slip pad 127 may be attached to a bottom of the base 111. For example, the non-slip pad 127 may be attached to the bottom of the base 111 via adhesive (but is not limited to this attachment means). The non-slip pad may ensure that the set of inflatable devices 110 do not slip when in use.

The main body 113 may be attached to the base 111 and may extend upwardly (vertically) therefrom. The main body 113 may be defined by at least two airbags 114 stacked vertically and sharing a common interior 115 (FIGS. 5-6). Preferably, as shown, the at least two airbags 114 may include three airbags. The airbags 114 may be made from a durable rubber material.

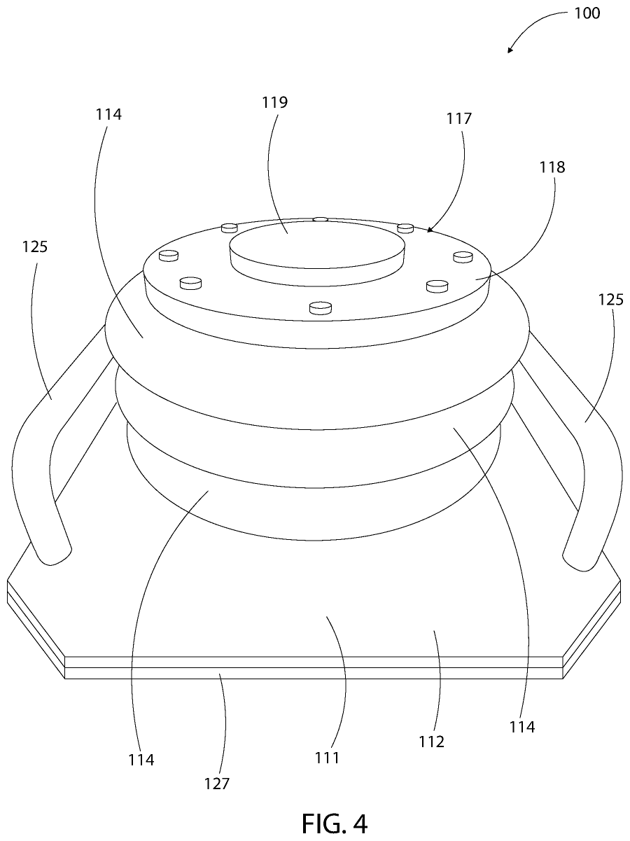

As shown in FIGS. 4-6, the support plate 117 may be attached atop the main body 113. As shown in FIG. 4, the support plate 117 may include a first plate 118 and a second plate 119. The first plate 118 may be made from a heavy duty material, such as steel; and the second plate 119 may be made from a non-slip material, such as rubber. As shown in FIG. 4 particularly, the first plate 118 may be attached at a center of the main body 113 and may extend upwardly therefrom; and the second plate 119 may be attached at a center of the first plate 118 and may extend upwardly therefrom. As shown, the first plate 118 may include a larger diameter than the second plate 119. When using the system 100, the second plate 119 may be the portion that abuts a frame or jacking points of the vehicle 5, as demonstrated in FIG. 3. Thereby, the support plate 117 may aid in support of the vehicle 5 whilst preventing slipping of the vehicle 5 and/or damage to the vehicle 5 due to the rubber second plate 119.

As shown particularly in FIG. 3, the inflation control unit 116 may be attached to the base 111. The inflation control unit 116 may be in communication with the common interior 115 and may include an inlet 121 and an outlet 122. The inlet 121 may be configured for connection with the airline-assembly 130 to receive compressed air therefrom (thus moving the inflatable device 110 into the inflated position 123). In some embodiments, the inlet 121 may include a valve (not illustrated) that enables the user to selectively close or open the inlet 121. The outlet 122 may be configured to expel the compressed air from the common interior 115, thereby moving the inflatable device 120 into the deflated position 124. The outlet 122 may also include a valve (not illustrated). In some embodiments, the user may manually open the outlet 122 to expel compressed air. In additional embodiments, the outlet 122 may include a relief valve, enabling the inflation control unit 116 to automatically expel some compressed air if the common interior 115 is overfilled.

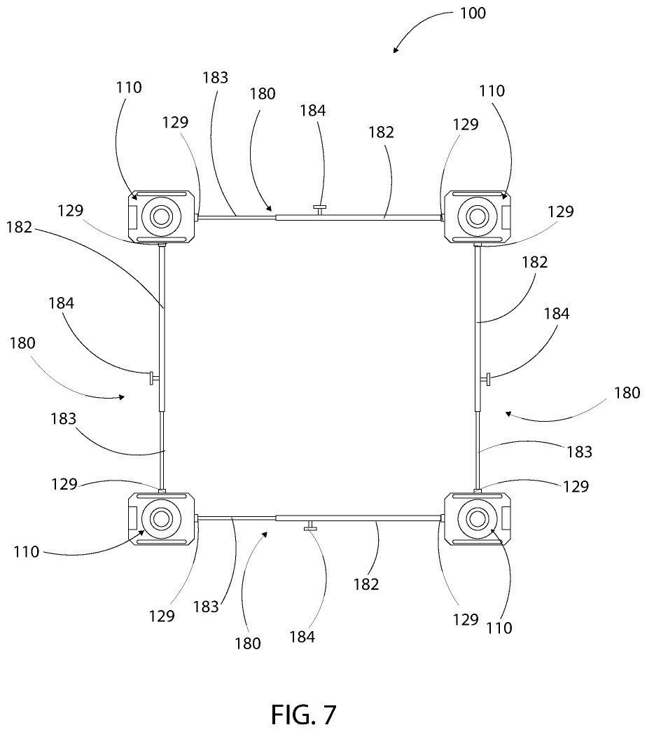

In some embodiments, as shown in FIG. 7, the system 100 may further comprise a set of telescopic members 180 connecting the set of inflatable devices 110 together. Particularly, the set of telescopic members 180 may each include a main telescopic portion 182, at least one extendable portion 183 configured for movement in and out of the main telescopic portion 182 and a locking mechanism 184 configured to lock the at least one extendable portion 183 at a particular position relative to the main telescopic portion 182 (at a desired length for the particular telescopic member 180). In some examples, as shown, the set of telescopic members 180 may include a set of four telescopic members 180. In this embodiment, each of the set of inflatable devices 110 may include anchor portions 129 located on at least two sides of the base 111, allowing for the connection of the telescopic assembly 180. Particularly, as shown, one of the anchor portions 129 on each of the set of inflatable devices 110 may connect to the main telescopic portion 182 and another one of the anchor points 129 on each of the set of inflatable devices 110 may connect to the at least one extendable portion 183. This may transform the set of inflatable devices 110 into one unit.

As shown in FIG. 7, the locking mechanism 184 may include a screw-type lock. Particularly, in this embodiment, each main telescopic portion 182 may include an aperture through which a threaded shaft of the screw-type lock is inserted (not illustrated), and a handle of the screw-type lock may then be twisted to selectively lock the at least one extendable portion 183 at a desired position (length) relative to the main telescopic portion 182. In some embodiments, the main telescopic portion 182 and the at least one extendable portion 183 may be made from (but are not limited to) an aluminum material.

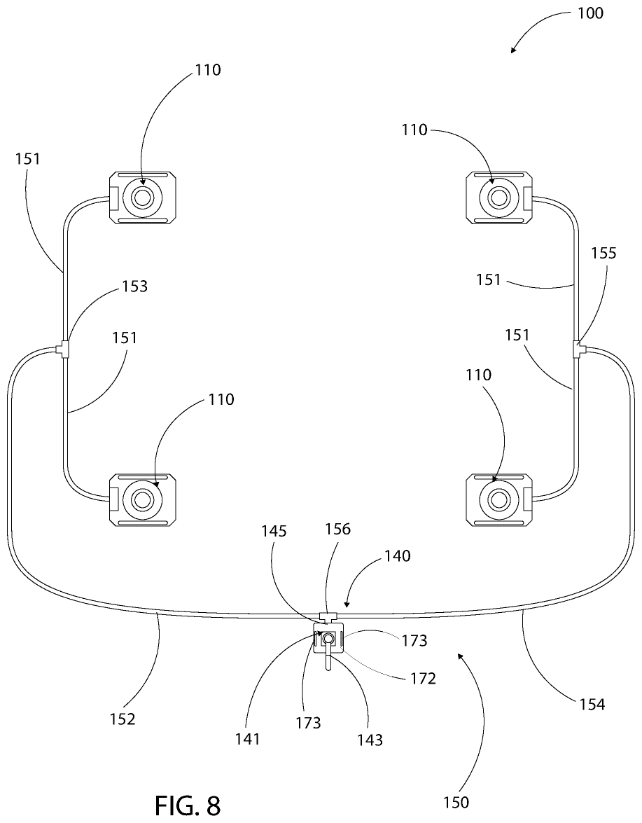

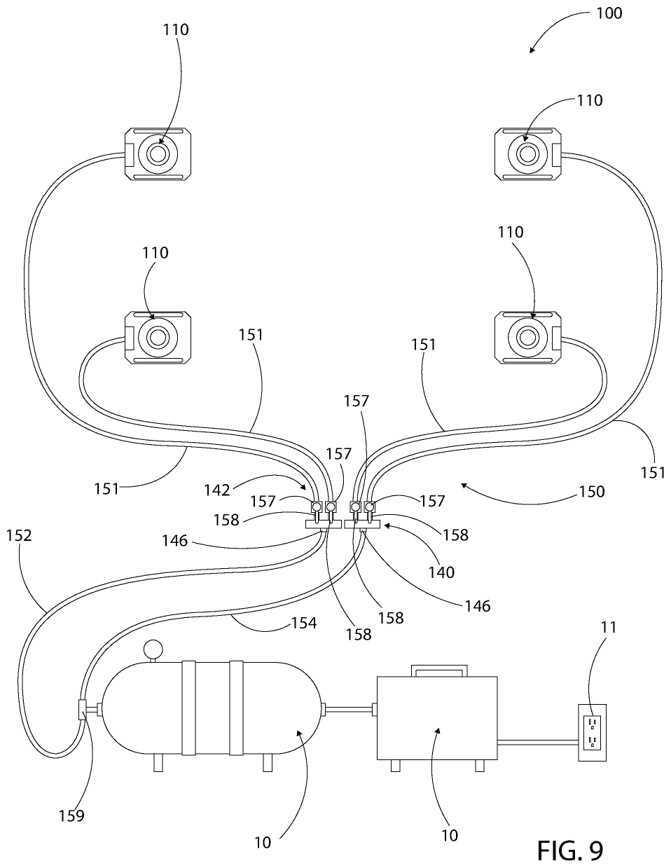

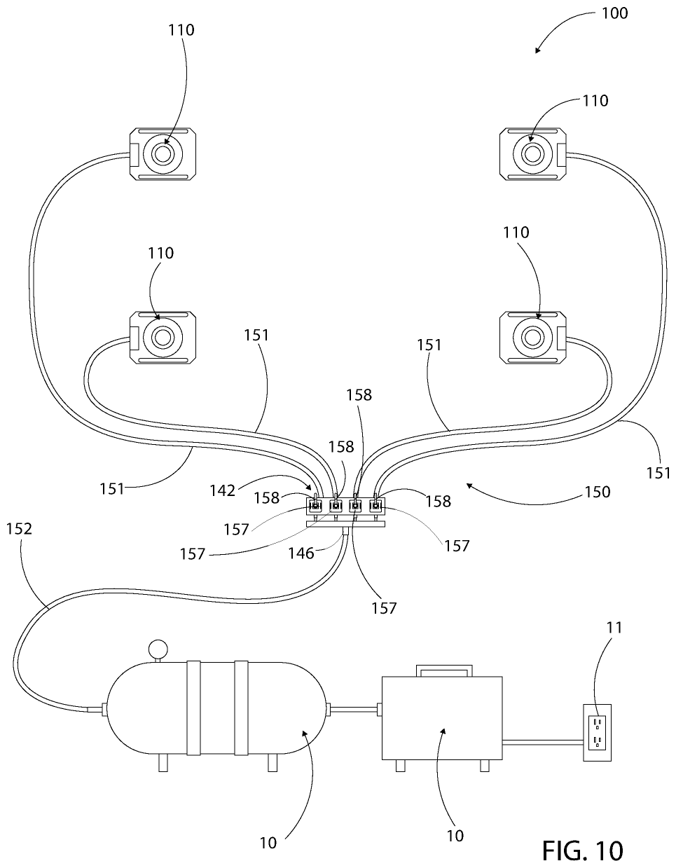

As shown specifically via pictorial diagrams in FIGS. 8-10, the air-line assembly 130 may include a conduit system 150 and a main control valve 140. As shown in FIG. 8 particularly, in some embodiments, the main control valve 140 may be attached to a base plate 172 including handles 173 for easy transportation thereof. The main control valve 140 may be configured for connection with a compressed air supply 10 (FIGS. 9-10) to intake the compressed air through the air-line assembly 130. This connection may be direct or indirect. In some examples, the compressed air supply 10 may be a compressed air tank, an air compressor, or both (as shown in FIGS. 9-10). As such, as also shown in FIGS. 9-10, the air compressor may be connected to a power supply 11. In some embodiments, these may be auxiliary to the system 100. As such, the system 100 may be configured for use with any existing compressed air supply 10.

The conduit system 150 may be configured to supply the compressed air from the main control valve 140 (when connected/in communication with the compressed air supply 10) to the inlet 121 of each of the set of inflatable devices 110, thereby moving the set of inflatable devices 110 into the inflated position 123 and lifting the vehicle 5. Particularly, the conduit system 150 may include one device conduit 151 per inflatable device 110. For example, as shown in FIGS. 8-10, the conduit system 150 may include four device conduits 151 and each of the four device conduits 151 may be configured for connection, at one end, with the inlet 121 of one of the four inflatable devices 110. The device conduits 151 may include one of a female or male interface (i.e., a female interface 162 as shown in FIG. 3) and the inlet 121 of the inflatable devices 15 may include another one of the female or male interfaces (i.e., a male interface 126 as shown in FIG. 3) to connect the device conduits 151 to the inlets 121. In some embodiments, the female interfaces and the male interfaces may be quick connectors.

The four device conduits 151 may then attach, at another end, with the main control valve 140 (or at least placed in communication with the main control valve via additional conduits, as will be discussed below). In some embodiments, the set of inflatable devices 110 may be moved into the inflated position 123 simultaneously. In some examples of this embodiment, as demonstrated via the diagram in FIG. 8, the main control valve 140 may include a single open and close valve 141. For example, the single open and close valve 141 may include a ball valve having a first handle 143 mounted to an exterior of the single open and close valve 141 for easy opening and closing thereof.

The conduit system 150 may further include a pair of conduits. For the sake of clarity, the pair of conduits will be discussed and illustrated with two separate reference numbers but it should be appreciated that the pair of conduits are contemplated to be identical and interchangeable. As shown in FIGS. 8-10, the pair of conduits may include a first main conduit 152 and a second main conduit 154.

As shown specifically in FIG. 8, in some embodiments, the first main conduit 152 may be placed at a first side (relative to the vehicle 5), i.e., a left side, and the second main conduit 154 may be placed at a second side (relative to the vehicle 5), i.e., a right side. In this embodiment, a first connector 153 may be provided and configured to connect two of the four device conduits 151 together and also connect the connect two of the four device conduits to the first main conduit 152. For example, the first connector 153 may be a T-fitting (or a Y-fitting) configured to connect together the device conduits 151 that are attached to inflatable devices 110 on the first side of the vehicle 5, and also attach these device conduits 151 to the first main conduit 152.

Similarly, a second connector 155 may connect another two of the four device conduits 151 together and to the second main conduit 154. Again, for example, the second connector 155 may also be a T-fitting (or again a Y-fitting) configured to connect together the device conduits 151 that are attached to inflatable devices 110 on the second side of the vehicle 5 together, and to also attach these device conduits 151 to the second main conduit 154. Further, a third connector 156 may be provided and configured to connect the first main conduit 152 and the second main conduit 154 to an output portion 145 of the main control valve 140 (in this example single open and close valve 141). Thereby placing the device conduits 151 in communication with the main control valve 140.

In some embodiments, the main control valve 140 (in the example illustrated in FIG. 8, the single open and close valve 141) may include a male interface configured to mate with a female interface (not illustrated) on the compressed air supply 10. As such, once the main control valve 140 is connected to the compressed air supply 10 and the system 100 is ready to accept the compressed air (valve(s) are open), the compressed air may travel from the compressed air supply through the main control valve 140 (again, in this example the single open and close valve 141), into each of the main conduits 152, 154, through the device conduits 151 and into the inflatable devices 110 simultaneously, thereby moving the set of inflatable devices 110 into the inflated position 123 simultaneously.

Another example is demonstrated via the diagrams in FIGS. 9-10, in which enables the set of inflatable devices 110 to be moved into the inflated position 123 both simultaneously or independently. As shown, in this example the main control valve 140 may include a quadruple 4-way valve 142. The conduit system 150 may again include one device conduit 151 per inflatable device 110 (particularly four device conduits 151 for the four inflatable devices 110). As shown in FIGS. 9-10, the quadruple 4-way valve 142 may include four outlets 157 having four independent valves that are independently connectable to one of the four device conduits 151. In some examples, the valves may each include a ball valve having a second handle 158 mounted to an exterior of the quadruple 4-way valve 142 for easy opening and closing of the valve.

In this embodiment, the compressed air may be supplied to the quadruple 4-way valve 142 via two airlines (rather than the main control valve 140 being directly connected to the compressed air supply 10 as in the embodiment discussed above and demonstrated in FIG. 8). For example, in this embodiment as demonstrated in FIG. 9, the pair of conduits 152, 154 may be used to connect to, at one end, the compressed air supply 10 and connect, at another end, to the quadruple 4-way valve 142; thereby enabling the supply of the compressed air to the quadruple 4-way valve 142. In this embodiment, the first main conduit 152 and the second main conduit 154 may be configured to connect to an input portion 146 of the main control valve 140 (the quadruple 4-way valve 142 in this example), as shown in FIG. 9. A fourth connector 159 may be provided and configured to connect the pair of conduits 152, 154 together and to the compressed air supply 10. The fourth connector 159 may include an interface, (i.e., a male interface), for mating with the female interface (not illustrated) on the compressed air supply 10.

In other embodiments, as shown in FIG. 10, only one of the pair of conduits 152, 154 (shown in this figure to be 152 as an example) may be used. In other embodiments still, the quadruple 4-way valve 142 may include a male interface, similar to the single open and close valve 141 above, allowing the quadruple 4-way valve 142 to mate with the female interface on the compressed air supply 10 directly.

The quadruple 4-way valve 142 may enable a user to independently prevent or allow the compressed air to move into each device conduit 151 (and thus each inflatable devices 110) independently. As such, to independently move the set of inflatable devices 110 into the inflated position 123, once the compressed air supply 10 has been connected to the quadruple 4-way valve 142, the user may, one by one, open each valve/outlet 157. For example, the user may open one valve/outlet 157, wait until the inflatable device 110 connected to that valve/outlet 157 is in the inflated position 123, and then open another valve/outlet 157 to inflate another inflatable device 110. To enable the set of inflatable devices 110 to be moved into the inflated position 123 simultaneously (using the quadruple 4-way valve 142), the user may simply open all valves 157 to permit the compressed air to simultaneously move through the four device conduits 151 and into the four inflatable devices 110.

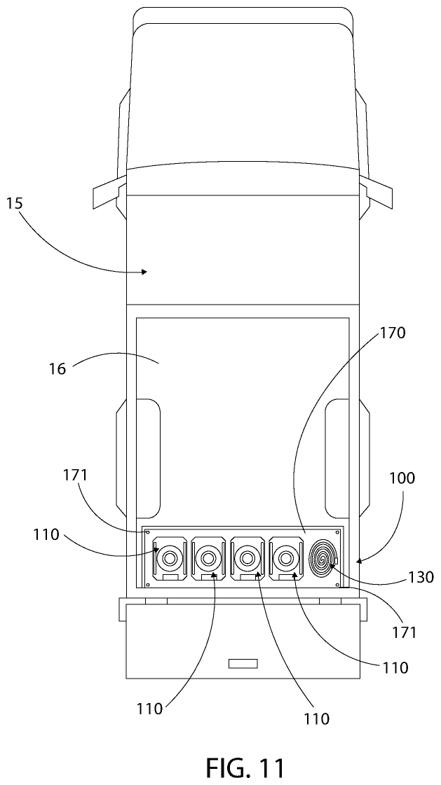

In additional embodiments, the system 100 may be constructed to be a mobile system. In this embodiment, as shown in FIG. 11, the system 100 may be stored or incorporated into a bed 16 of a truck 15, enabling individuals to transport the system 100 to different jobs. For example, in this embodiment, the system 100 may include a fitted mold 170 securing the set of inflatable devices 110 and the air-line assembly 130 therein. The fitted mold 170 may include anchor points 171 that may enable the user to bolt the fitted mold 170 to the bed 16 of the truck 15. Further, in this embodiment, the system 100 may be made of or constructed with lightweight materials. For example, instead of steel, the inflatable devices 110 may include aluminum.

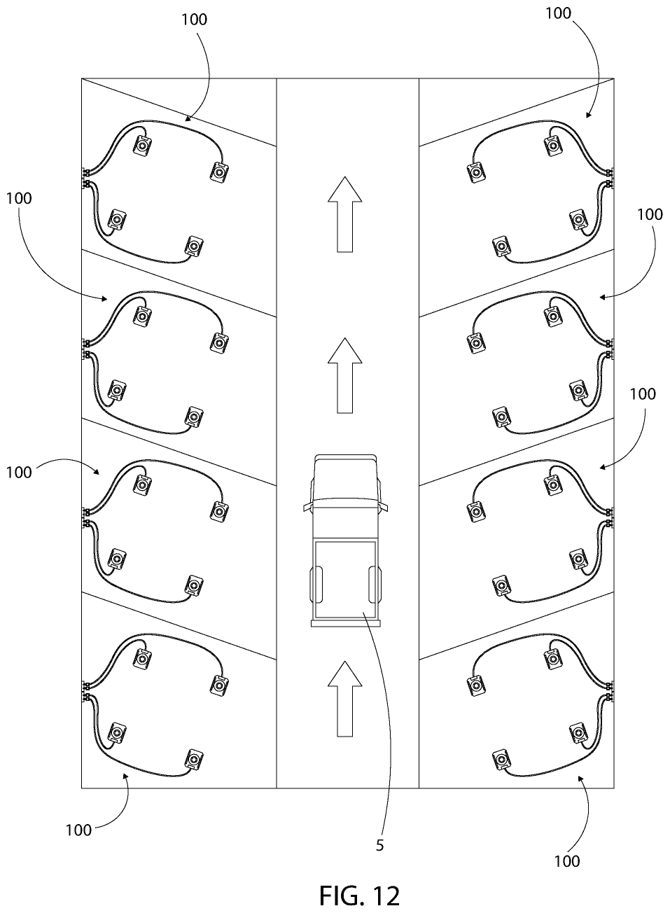

It is also contemplated that the system 100 may be utilized in various applications. In particular, the system 100 may be particularly useful for mechanic stores, tire stores, etc. For example, as shown in FIG. 12, the system 100 may be provided in a ‘tire store’ arranged as a drive-thru tire swap center' having a plurality of bays each sized for a vehicle 5 to drive into. Each bay may include one of the systems 100 positioned and ready for use. As such, the vehicle 5 may be driven into a bay, positioned such that each of the set of inflatable devices 110 abut jacking points of the vehicle 5, and the compressed air supply 10 (FIGS. 9-10) may be switched on to inflate the inflatable devices 110 and lift the vehicle 5.

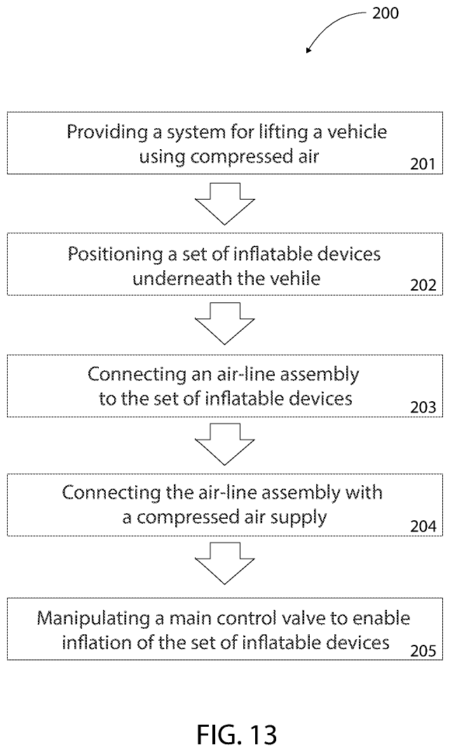

Referring now to FIG. 13 showing a flow diagram illustrating a method 200 of lifting a vehicle using compressed air, according to an embodiment of the present disclosure. In particular, the method 200 may include one or more components or features of the system 100 as described above. As illustrated, the method 200 may include the steps of: step one 201, providing the system as above; step two 202, positioning each of the set of inflatable devices underneath the vehicle such that the support plate of each of the set of inflatable devices abuts an underside of the vehicle (or particularly, jacking points of the vehicle); step three 203, connecting the air-line assembly to the inflation control unit on each of the set of inflatable devices; step four 204, connecting the main control valve with the compressed air supply (directly or indirectly such that the main control valve is able to control the supply of compressed air to the system from the compressed air supply); and step 205, manipulating the main control valve to enable conveyance of the compressed air through the air-line assembly and into the inlet of each of the set of inflatable devices, thereby filling the common interior of each of the set of inflatable devices with compressed air, moving the set of inflatable devices into the inflated position, and lifting the vehicle.

It should be noted that certain steps are optional and may not be implemented in all cases. Optional steps of method 200 are illustrated using dotted lines in FIG. 13 so as to distinguish them from the other steps of method 200. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for lifting a vehicle with compressed air and using a system to lift a vehicle with compressed air are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A system for lifting a vehicle using compressed air comprising:
a set of inflatable devices configured for movement between an inflated position and a deflated position, the set of inflatable devices including a greater height in the inflated position than in the deflated position, the set of inflatable devices each including:
a base including a substantially planar body;
a main body attached to the base, the main body being defined by at least two airbags stacked vertically and sharing a common interior;
an inflation control unit attached to the base and in communication with the common interior, the inflation control unit including an inlet; and
a support plate attached atop the main body; and
an air-line assembly configured to selectively supply compressed air to the set of inflatable devices, the air-line assembly including a conduit system and a main control valve, the main control valve configured for connection with a compressed air supply to intake the compressed air into the air-line assembly, the conduit system configured to supply the compressed air to the inlet of each of the set of inflatable devices, thereby moving the set of inflatable devices into the inflated position and lifting the vehicle.

2. The system of claim 1, wherein the set of inflatable devices are moved into the inflated position simultaneously.

3. The system of claim 2, wherein the set of inflatable devices are moved into the inflated position independently.

4. The system of claim 3, wherein the set of inflatable devices includes four inflatable devices.

5. The system of claim 4, wherein the conduit system includes four device conduits, and wherein each of the four device conduits are configured for connection with the inlet of one of the four inflatable devices.

6. The system of claim 5, wherein the conduit system further includes a pair of main conduits, the pair of main conduits including a first main conduit and a second main conduit.

7. The system of claim 6, wherein the main control valve includes a single open and close valve.

8. The system of claim 7, wherein the conduit system further includes a first connector configured to connect two of the four device conduits together and to the first main conduit, wherein the conduit system further includes a second connector configured to connect another two of the four device conduits together and to the second main conduit, and wherein the conduit system further includes a third connector configured to connect the first main conduit and the second main conduit to an output portion of the main control valve.

9. The system of claim 6, wherein the main control valve includes a quadruple 4-way valve.

10. The system of claim 9, wherein at least one of the first main conduit and the second main conduit are configured to connect to an input portion of the main control valve and wherein the conduit system further includes a fourth connector configured to connect the first main conduit and the second main conduit together and to the compressed air supply.

11. The system of claim 1, wherein the at least two airbags includes three airbags.

12. The system of claim 11, wherein the inflation control unit further includes an outlet configured to expel the compressed air from the common interior.

13. A system for lifting a vehicle using compressed air comprising:
a set of four inflatable devices configured for movement between an inflated position and a deflated position, the set of four inflatable devices including a greater height in the inflated position than in the deflated position, the set of four inflatable devices each including:
a base including a substantially planar body;
a main body attached to the base, the main body being defined by at least three airbags stacked vertically and sharing a common interior;
an inflation control unit attached to the base and in communication with the common interior, the inflation control unit including an inlet and an outlet, the outlet configured to expel compressed air from the common interior; and
a support plate attached atop the main body; and
an air-line assembly configured to selectively supply compressed air to the set of four inflatable devices, the air-line assembly including a conduit system and a main control valve, the main control valve configured for connection with a compressed air supply to intake the compressed air into the air-line assembly, the conduit system including four device conduits and a pair of main conduits having a first main conduit and a second main conduit, each of the four device conduits configured for connection with the inlet of one of the set of four inflatable devices and configured to supply the compressed air thereto, thereby moving the set of four inflatable devices into the inflated position and lifting the vehicle.

14. The system of claim 13, wherein the set of four inflatable devices are moved into the inflated position simultaneously.

15. The system of claim 14, wherein the set of four inflatable devices are moved into the inflated position independently.

16. The system of claim 15, wherein the main control valve includes a single open and close valve, wherein the conduit system further includes a first connector configured to connect two of the four device conduits together and to the first main conduit, wherein the conduit system further includes a second connector configured to connect another two of the four device conduits together and to the second main conduit, and wherein the conduit system further includes a third connector configured to connect the first main conduit and the second main conduit to an output portion of the single open and close valve.

17. The system of claim 15, wherein the main control valve includes a quadruple 4-way valve, wherein at least one of the first main conduit and the second main conduit are configured to connect to an input portion of the quadruple 4-way valve and wherein the conduit system further includes a fourth connector configured to connect the first main conduit and the second main conduit together and to the compressed air supply.

18. A method of lifting a vehicle using compressed air comprising:
providing a system including:
a set of inflatable devices configured for movement between an inflated position and a deflated position, the set of inflatable devices including a greater height in the inflated position than in the deflated position, the set of inflatable devices each including:
a base including a substantially planar body;
a main body attached to the base, the main body being defined by at least two airbags stacked vertically and sharing a common interior;
an inflation control unit attached to the base and in communication with the common interior, the inflation control unit including an inlet; and
a support plate attached atop the main body; and
an air-line assembly configured to selectively supply compressed air to the set of inflatable devices, the air-line assembly including a conduit system and a main control valve, the main control valve configured for connection with a compressed air supply to intake the compressed air into the air-line assembly, the conduit system configured to supply the compressed air to the inlet of each of the set of inflatable devices, thereby moving the set of inflatable devices into the inflated position and lifting the vehicle;
positioning each of the set of inflatable devices underneath the vehicle such that the support plate of each of the set of inflatable devices abuts an underside of the vehicle;
connecting the air-line assembly to the inflation control unit on each of the set of inflatable devices;
connecting the main control valve with the compressed air supply; and
manipulating the main control valve to enable conveyance of the compressed air through the air-line assembly and into the inlet of each of the set of inflatable devices, thereby:
filling the common interior of each of the set of inflatable devices with compressed air;
moving the set of inflatable devices into the inflated position; and
lifting the vehicle.

19. The method of claim 18, wherein the set of inflatable devices are moved into the inflated position simultaneously.

20. The method of claim 19, wherein the set of inflatable devices are moved into the inflated position independently.
